(19) United States
(12) Patent Application Publication
(10) Pub. No.: US 2015/0367938 A1
(43) Pub. Date: Dec. 24, 2015

(54) OCEAN - AIR VEHICLE

(71) Applicant: AeroVironment Inc., Monrovia, CA (US)

(72) Inventors: Thomas Zambrano, Long Beach, CA (US); Tyler MacCready, Pasadena, CA (US)

(73) Assignee: AEROVIRONMENT INC., Monrovia, CA (US)

(21) Appl. No.: 14/263,944

(22) Filed: Apr. 28, 2014

Related U.S. Application Data
(63) Continuation of application No. PCT/US2012/000529, filed on Oct. 29, 2012.
(60) Provisional application No. 61/628,342, filed on Oct. 28, 2011.

(51) Int. Cl. B64C 35/00; B64C 39/02; B63G 8/00; B63H 5/125

(52) U.S. Cl. CPC B64C 35/005; B63H 5/125; B64C 35/00; B64C 35/003; B64C 39/024; B63G 8/001; B63G 2008/004; B63G 2008/005; B64C 2201/021; B64C 2201/126; B64C 2201/14

(57) ABSTRACT

A vehicle having a wing, a forward propeller configured for forward flight, and an aft propeller configured for submerged travel in a rearward direction. The vehicle center of mass is aft of its floating center of buoyancy, and center of mass and the floating center of buoyancy lie between the first and second propellers. The vehicle has a natural floating orientation in which the vehicle, while floating, has its first propeller located in the air and positioned for initiating airborne flight in a forward direction, and in which the vehicle has its second propeller located in the liquid and positioned for initiating submerged travel in a rearward direction.

This application is a Continuation Application of International PCT Application No. PCT/US2012/000529, filed Oct. 29, 2012, which claims the benefit of U.S. Provisional Application No. 61/628,342, filed Oct. 28, 2011, each of which is incorporated herein by reference for all purposes.

The present invention relates to a vehicle configured to transition between airborne, floating and submersed modes of operation.

### BACKGROUND OF THE INVENTION

As unmanned aerial vehicles (UAV's) and unmanned underwater vehicles (UUV's) become increasingly pervasive in the skies and seas, their respective designs are becoming increasingly disparate. UUV's, for example, show a trend toward bulkier and heavier designs, further and further from anything that could realize atmospheric flight. Nevertheless, numerous applications would exist for a vehicle that could fly to a location, conduct submerged activities, and then fly back to a home base. Such applications include remote weather sensing, ocean data and sample acquisition (e.g., searching for spilled oil), and military surveillance and communication networks.

The design of a vehicle that can operate both as a UAV and a UUV, i.e., as an ocean-air vehicle (OAV), raises a number of significant challenges. A first such challenge preventing UAV's from entering the UUV space is waterproofing. UAV's are not typically hermetically sealed, partly because ensuring a seal introduces additional weight and manufacturing costs. In addition, sealing UAV electronics, perhaps containing a gaseous environment, can also increase the buoyancy of a body already too buoyant to reach or dwell at any depth underwater.

Another such challenge is that UAV's and UUV's respectively require propulsion systems that will work in the air, and the water. Since the characteristics of a propeller and an airfoil depend on the density of the fluid in which they travel, this leads to significant challenges in propulsion design.

Two challenges having competing interests are the need for communication and the risks from buoyant debris and wave activity. Radio frequency signals, as well as much of the electromagnetic spectrum in general, are severely attenuated underwater, and get weaker at greater depths. Nevertheless, near-surface depths, e.g., less than 3 m (9.8 ft) underwater, carry much greater dangers from floating debris and turbulent flow (e.g., wave) effects.

Finally, buoyancy considerations complicate OAV design. The relationship between the center of mass (CM), the center of buoyancy (CB) and the center of lift (CL) is complex for an OAV, as it should function in highly diverse environments. Better characteristics lead to efficient operation.

Amphibious aircraft (e.g., seaplanes) are known to transition between the floating and airborne modes of operation, but a water take-off of a typical aircraft on pontoons is very difficult in anything but calm, flat water, as they must strike each wave at the relatively high (from a boating standpoint) minimum speed that the plane needs to attain flight. Thus, another challenge for a robust OAV is the ability to conduct air-water and water-air transitions in harsh oceanic environments (e.g., through choppy waves, large swells, varying or high wind speed, changing wind directions, storms). This challenge is especially difficult for an unmanned OAV, given that unmanned vehicles tend to be smaller, and thus will have a smaller relative size to an ocean swell.

It is known for submarines to launch missiles from underwater. Floating-launch missiles and spacecraft launched from sloating platforms have been proposed and/or developed.

Accordingly, there has existed a need for a waterproof OAV that is light enough to fly, dense enough to submerge, has a workable propulsion system for any of its operating environments, has a control system capable of operating when communications are not available, and is able to transition between the underwater and flying regimes of operation, even in harsh conditions. Preferred embodiments of the present invention may satisfy these and other needs, and provide further related advantages.

### SUMMARY OF THE INVENTION

In various embodiments, the present invention solves some or all of the needs mentioned above, typically providing a waterproof OAV that is light enough to fly, dense enough to submerge, and having a workable propulsion system for any of its operating environments. It may have a control system capable of operating when communications are not available, and may be able to transition between the underwater and flying regimes of operation, even in harsh conditions, while being configured for efficient operation in every operating environment.

A typical vehicle under the invention includes a wing defining opposite forward and aft directions that are opposite to one another, a first propeller, a second propeller, and a propeller drive system. The first propeller is configured for use in a gaseous environment (e.g., air), and is mounted for rotation around a first propeller axis that defines a first propeller forward thrust vector having a propulsionally significant component in the forward direction. The second propeller is configured for use in a liquid environment (e.g., water), and is mounted for rotation around a second propeller axis that defines a second propeller aft thrust vector having a propulsionally significant component in the aft direction.

The drive system includes one or more motors. It is configured to drive the first propeller in rotation about the first propeller axis such that it creates thrust along the first propeller forward thrust vector to support airborne flight in the forward direction. The drive system is further configured to drive the second propeller in rotation about the second propeller axis such that it creates thrust along the second propeller aft thrust vector to support aft, submerged travel in a body of liquid (i.e., traveling rearward while submerged).

The vehicle is characterized by a center of mass and a floating center of buoyancy. The center of mass is aft of the floating center of buoyancy, and the center of mass and the floating center of buoyancy lie along the first axis between the first and second propellers.

Advantageously, the present invention may provide for a vehicle having a natural floating orientation in which the vehicle, while floating, has its first propeller located in the air and positioned for initiating airborne flight in a forward direction. The present invention may further provide for a vehicle having a natural floating orientation in which the vehicle, while floating, has its second propeller located in the water and positioned for initiating submerged travel in a rearward direction.

Other features and advantages of the invention will become apparent from the following detailed description of the preferred embodiments, taken with the accompanying drawings, which illustrate, by way of example, the principles of the invention. The detailed description of particular preferred embodiments, as set out below to enable one to build and use an embodiment of the invention, are not intended to limit the enumerated claims, but rather, they are intended to serve as particular examples of the claimed invention.

### BRIEF DESCRIPTION OF THE DRAWINGS

FIG. 1 is a perspective view of a first ocean-air vehicle (OAV) embodying the present invention.

FIG. 2 is a second perspective view of the OAV depicted in FIG. 1.

FIG. 3 is a rear view of the OAV depicted in FIG. 1.

FIG. 4 is a third perspective view of the OAV depicted in FIG. 1.

FIG. 5 is a schematic view of the OAV depicted in FIG. 1, during forward (winged) flight.

FIG. 6 is a schematic view of the OAV depicted in FIG. 1, floating in its natural floating orientation, which is a gravitationally nose-up orientation.

FIG. 7 is a schematic view of the OAV depicted in FIG. 1, submerged in its natural floating orientation.

FIG. 8 is a perspective view of a second OAV embodying the present invention.

FIG. 9 is a partial side view of a second variation of the first or second embodiments of the invention.

FIG. 10 is a partial side view of a third variation of the first or second embodiments of the invention.

FIG. 11 is a partial side view of a fourth variation of the first or second embodiments of the invention.

FIG. 12 is a partial side view of a fifth variation of the first or second embodiments of the invention.

FIG. 13 is a partial side view of a sixth variation of the first or second embodiments of the invention.

FIG. 14 is a partial view of a seventh variation of the first or second embodiments of the invention.

FIG. 15 is a method embodying the invention.

### DETAILED DESCRIPTION OF THE PREFERRED EMBODIMENTS

The invention summarized above and defined by the enumerated claims may be better understood by referring to the following detailed description, which should be read with the accompanying drawings. This detailed description of particular preferred embodiments of the invention, set out below to enable one to build and use particular implementations of the invention, is not intended to limit the enumerated claims, but rather, it is intended to provide particular examples of them.

The first embodiment of the invention is an ocean-air vehicle (OAV), which is a new class of unmanned vehicles. This OAV is configured for use with a body of water defining a surface, i.e., the gas-liquid interface between the body of water and a gaseous atmosphere extending over the surface (e.g., the air-water interface being the surface of a body of water). This OAV is capable of operating above the surface in the gaseous atmosphere (e.g., the air) for vertical and/or lateral thrust airborne flight, under the surface in the body of liquid (e.g., underwater), and at the surface, and can transition between these modes of operation. OAV's may prove useful for a variety of functions, such as remote weather sensing, ocean data and sample acquisition, and military surveillance and communication networks. While there may be possible manned uses for this technology, the power-to-weight ratios achievable by smaller unmanned vehicles provide for particularly useful unmanned embodiments.

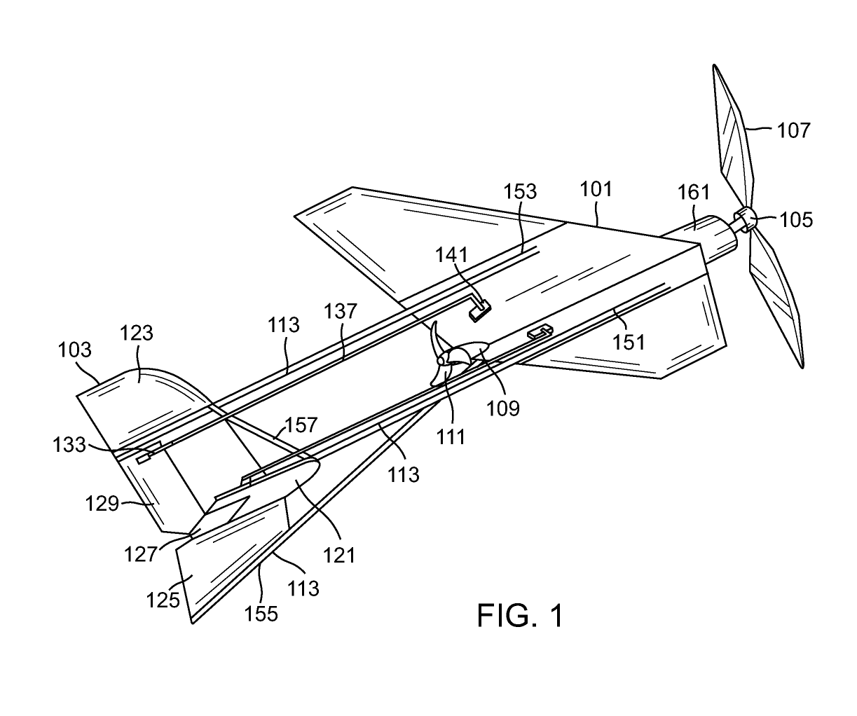

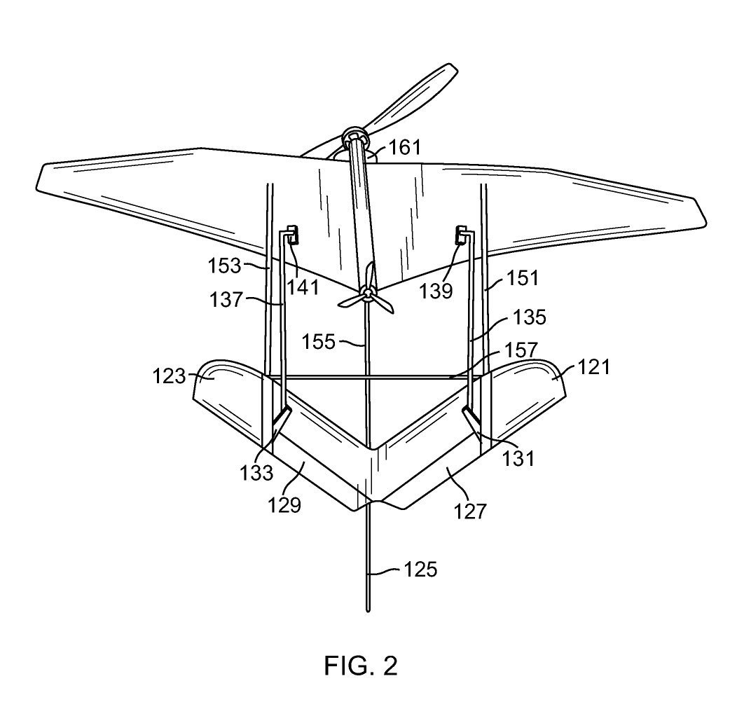

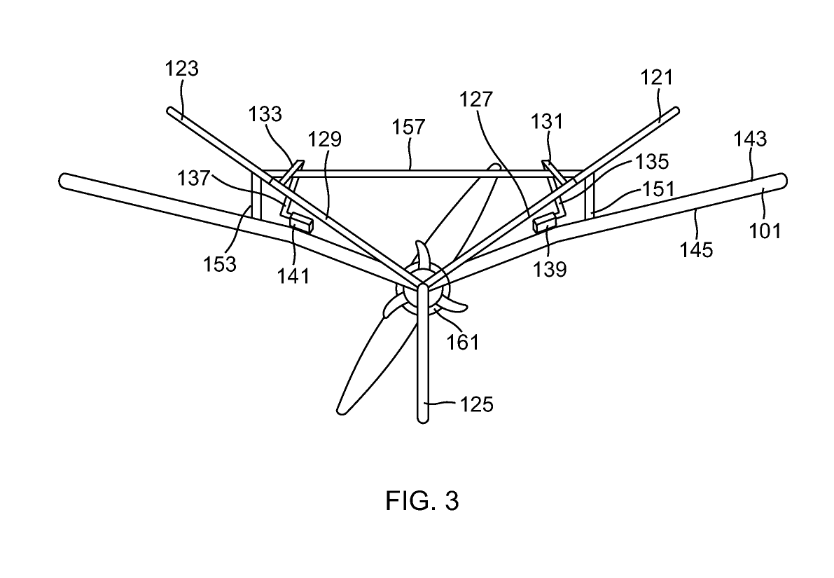

With reference to FIGS. 1-3, the OAV is configured with a wing 101, an empennage 103, a first, forward motor 105 configured to drive a first, forward propeller 107 in rotation, and a second, aft motor 109 configured to drive a second, aft propeller 111 in rotation. The wing and empennage define traditional starboard and port sides, upper and lower sides, and forward and aft directions, all with respect to the OAV operating within a gaseous environment (e.g., air) in a typical winged aircraft flight mode of operation. The wing and empennage are structurally connected together and supported with respect to one another not by a typical aircraft fuselage, but rather by three booms 113. Light materials such as carbon tubes might be used for this construction.

The empennage 103 has a V-tail including a starboard panel 121 and a port panel 123, and further has a downward-extending vertical stabilizer 125. The starboard and port V-tail panels respectively include starboard and port control surfaces 127, 129 (sometimes known as a ruddervators), the combined operation of which emulates the effects of a rudder and two elevators, as is well understood in the art of aircraft design. The V-tail control surfaces have respective starboard and port pylons 131, 133 connecting the control surfaces to aft ends of respective starboard and port control shafts 135, 137 that extend over the control surfaces. Forward ends of the control shafts connect to respective starboard and port servos 139, 141, which are mounted on an upper surface 143 of the wing 101, and which are configured as control surface actuators to drive the control shafts and thereby controllably rotate the control surfaces.

The three booms 113 include a first, starboard boom 151 extending from the upper surface of the wing 101 on the starboard side, to the starboard V-tail panel 121 at a location immediately outboard of its respective V-tail control surface. A second, port boom 153 extends from the upper surface of the wing on the port side, to the port V-tail panel 123 at a location immediately outboard of its respective V-tail control surface. A third, center boom 155 extends from an aft center portion of the wing on a lower surface 145 of the wing 101, downward to a bottom edge of the vertical stabilizer 125. The port and starboard booms are substantially parallel, and do not vary in their lateral distance apart, thereby minimizing drag when moving forward or backward. An aerodynamic strut 157 extends from a leading edge of the starboard V-tail panel to a leading edge of the port V-tail panel, connecting between them at substantially the location at which the starboard and port booms connect to their respective V-tail panels. This configuration provides for a strong and fairly rigid connection between the wing and the empennage with a minimum of structure, and with a minimum of weight in the aft portion of the OAV.

The operation of the forward motor 105, the aft motor 109, the starboard servo 135 and the port servo 137 are controlled by a control module 161 extending along the centerline of the wing 101 on the lower surface of the wing, and further extending out in front of the leading edge of the wing. The control module may include a power source, an antenna, and all flight control electronics typically used to control a remote control aircraft. Additionally or alternatively, the control module may include a power source and a programmable autopilot control system that is programmed to control the aircraft through a predetermined flight plan and/or submerged operation plan. The control system is further configured to control the drive system such that the forward propeller provides forward thrust that is used for propulsion when the vehicle is airborne, and such that the aft propeller provides aft thrust that is used for propulsion when the vehicle is submerged. To this end, the OAV may include typical flight control electronics and sensors found for automated vehicle control in UAVs and UUVs, such as an autopilot control system, a compass, an internal navigation system (e.g., accelerometers), a GPS system, and the like.

The forward motor 105 and forward propeller 107 are sized and efficiently configured to propel the OAV forward in flight. It should be understood in this context that an “efficient” configuration is one appropriate for flight rather than use in a liquid. More particularly, the forward propeller is mounted for rotation around a forward propeller axis that defines a forward propeller forward thrust vector having a substantial component in the forward direction. Thus, the forward propeller is configured for airborne flight for a standard winged aircraft. The forward motor and forward propeller are further configured to provide a level of thrust that is greater than the weight of the OAV when wet (i.e., they are configured to accelerate the OAV upward when the OAV is wet and floating nose-up, that is to say, oriented with its thrust line vertical with respect to gravity, in what might be considered a helicopter mode of operation). The forward motor is a brushless motor that can remain operational despite having been submerged and filled with water.

This embodiment of an OAV is configured to transition back and forth between a UAV mode of operation (e.g., atmospheric flight) and a UUV mode of operation (e.g., underwater operation). Transitioning between these regimes typically is done through an intermediate, floating mode of operation on the surface between the UAV and UUV regimes.

The OAV is characterized by a center of mass (CM), a mass, and a liquid-displacement volume. It is well understood that a liquid will exert an upward force (i.e., buoyancy) on an object immersed in it equal to the weight of the liquid displaced by the object. Thus, for an object to float it must weigh less than the volume of the liquid it displaces when fully submerged in the liquid (i.e., its density is less than that of the liquid). This embodiment of an OAV is configured to float, that is to say, its total density (i.e., mass per volume) is less than that of the liquid (e.g., water) in which it is intended to float.

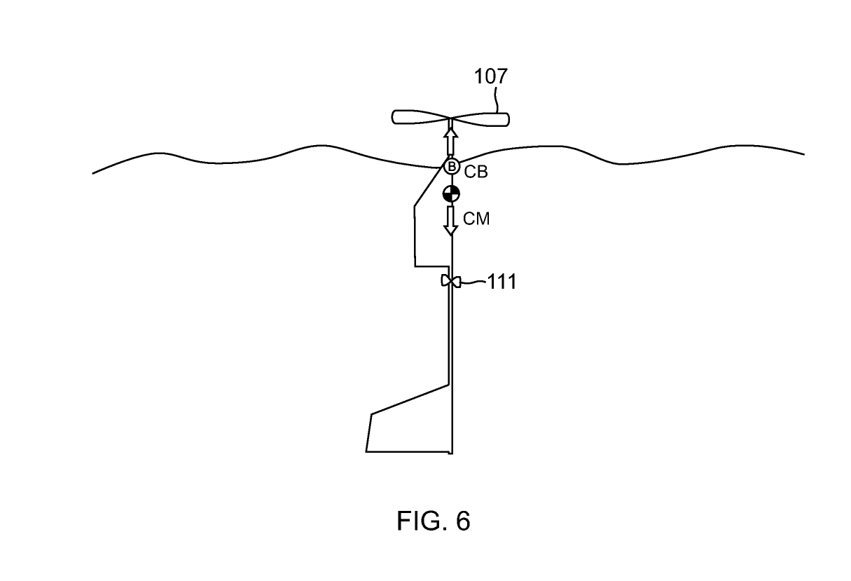

For the purposes of this application, the phrase “natural floating orientation” is defined as the most stable orientation in which the OAV can achieve a stable equilibrium state while floating in an unperturbed liquid. The most stable orientation is the one with the lowest gravitational potential energy while floating. The natural floating orientation establishes a natural floating depth. In the natural floating orientation, a portion of the OAV extends out of the water while the rest is submerged (see, e.g., FIG. 6). The natural floating orientation will be the one in which the CM of the OAV is the deepest under the surface of the water. The natural floating depth will be established as the depth of the CM when the OAV is floating in the natural floating orientation. This is the depth at which the total weight of the OAV is equal to the buoyancy of the submerged portion of the OAV.

It should be noted that the natural floating orientation of a traditional seaplane would be upside down as compared to its normal operating orientation. In its normal operating orientation, a traditional seaplane has its center of mass both well above its center buoyancy and well above the surface of the water. In the normal operating orientation, the seaplane does not have its lowest possible potential energy with respect to gravity while floating, and is therefore not in its most stable orientation.

In the natural floating orientation there will be a floating center of buoyancy (FCB) which will be directly above (and with respect to the aircraft axis of flight, forward of) the CM. Nevertheless, when the OAV is fully submerged, the OAVs center of buoyancy may shift based on the buoyancy of the portions of the OAV that are not submerged while floating. Thus the OAV is thus characterized by both a FCB and a submerged center of buoyancy (SCB).

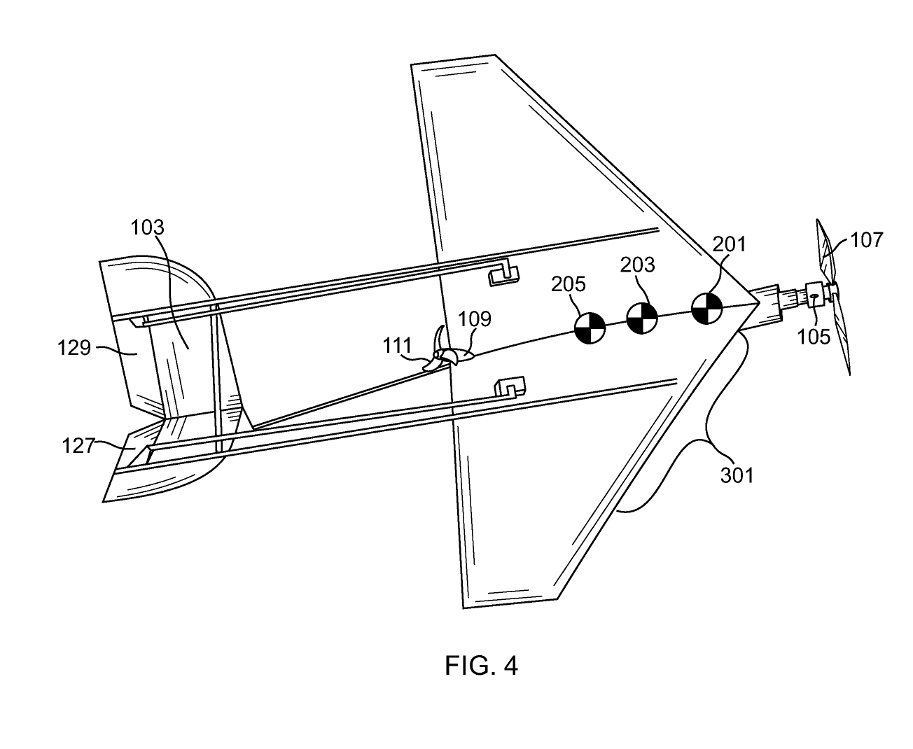

With reference to FIG. 4, the wing defines a primary axis of the OAV. Lying serially along this axis, from forward to aft, are the forward propeller 107, the forward motor 105, the FCB 201, the CM 203, the center of lift for the wing (CL) 205, the aft motor 109 and the aft propeller 111. The forward propeller axis preferably lies along the primary axis, and during normal operation the forward propeller forward thrust vector preferably extends forward along the primary axis. Thus, the FCB, the CM, the CL and the forward propeller axis are collinear.

As a result of CM and the FCB lying along the axis of the forward propeller (i.e., being collinear), the natural floating orientation provides for the forward propeller to be at the gravitational top of the OAV, and further provides for the forward propeller forward thrust vector (for normal operation) to point vertically upward (with respect to gravity). The OAV density is low enough to provide for the forward propeller to be supported such that it is located in the air (i.e., not submerged) when the OAV is floating in the natural floating orientation. Thus, the OAV is configured to take off vertically upward when the forward propeller provides forward thrust and the OAV is floating in its natural floating orientation. If the propeller was not supported so that it was fully in the air, it is less likely that it could generate the necessary speed to provide the lift to take off vertically unless the motor was extremely powerful.

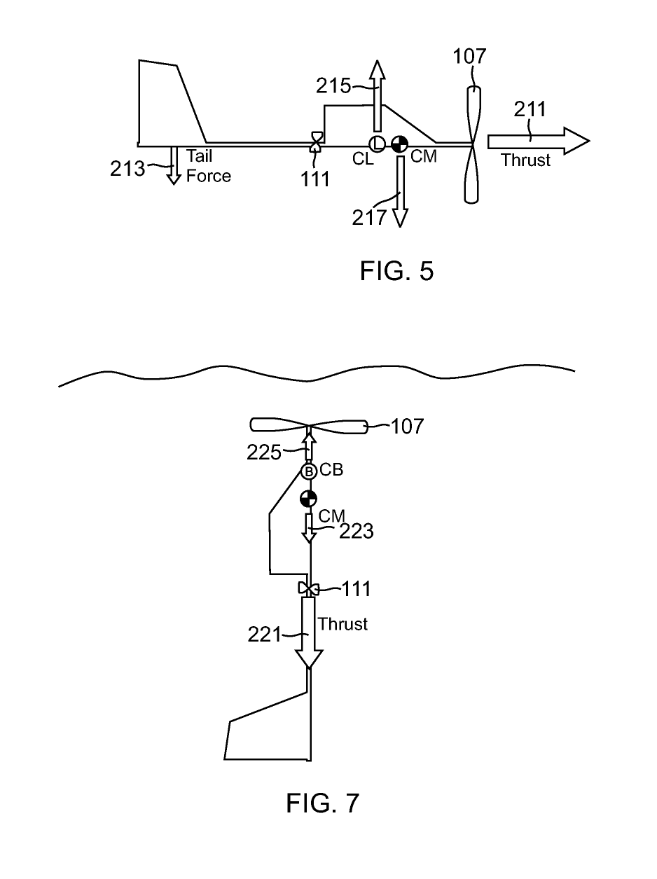

With reference to FIGS. 4-7, in typical UAV operation, the forward motor 105 rotates the forward propeller 107 at a speed adequate to provide the necessary forward thrust 211 for winged flight. The thrust is applied substantially along the primary axis of the OAV. The empennage provides a downward force 213, which is balanced out by the offset between the lift vector 215 through the CL 205 and the weight vector 217 through the CM 203, which is in turn the result of the CM being forward of the CL (as is typical for aircraft).

To transition from UAV operation to UUV operation, the flying OAV will typically fly slow and low over the water using the forward motor and propeller, and then cut power to the forward motor 105 to further slow the OAV and reach a close-to-minimum flight speed (i.e., come close to stall speed) before coming to rest in the water. The OAV has a lower overall density than the liquid in which it will operate (e.g., fresh water or salt water). With its overall buoyancy, and its CM 203 directly aft of the FCB 201 along the primary axis, the OAV will tend to float in a natural floating orientation in which the primary axis extends substantially vertically (i.e., in a nose-up orientation) with respect to gravity. From this orientation, the OAV may transition either to UUV operation, or back to UAV operation.

While in the water, the OAV will be subject to currents and waves that will disturb its orientation. For the greatest chance of a successful takeoff, the OAV primary axis should be as close to vertical as possible (with respect to gravity), and the forward propeller 107 should not be submerged. To compensate for rough seas, this later goal may be accomplished by using a forward propeller shaft that places the forward propeller significantly above the waterline while the OAV is floating in the natural floating orientation. However, while floating during windy conditions, the wind resistance of a higher forward propeller will cause more torque on the OAV, and make it harder to achieve a nose-up orientation. To avoid this, analysis and/or experimentation may be used to find the optimal propeller height above the surface for a target range of operational conditions.

To resume flight, with the forward propeller in the air and in a relatively vertical orientation (i.e., oriented for vertical flight thrust), the OAV forward motor drives the forward propeller to achieve a maximum forward thrust that is greater than the total weight of the OAV. The thrust launches the OAV in a relatively vertical direction from the water. The control surfaces 127, 129 may then be used to orient the aircraft for traditional winged flight.

From a floating mode of operation, the OAV may transition to UUV operation, by using the aft motor 109 and aft propeller 111. As previously noted, while in the water, the OAV will be subject to currents and waves that will disturb the orientation. Preferably the OAV primary axis should be nose-up and as close to vertical as possible to begin UUV operation, and the aft propeller should be fully submerged. To compensate for rough seas, this later goal may be accomplished by using an aft propeller that is located behind the CM, and preferably behind the wing, or even on or behind the empennage.

More particularly, the aft propeller is mounted for rotation around an aft propeller axis that defines an aft propeller aft thrust vector having a substantial component in the aft direction. The aft propeller and motor are sized and efficiently configured for thrust in a liquid environment. It should be understood in this context that an “efficient” configuration is one appropriate for use in a liquid rather than a gas. The aft motor is configured to drive the aft propeller in rotation about the aft propeller axis to create aft thrust along the aft propeller aft thrust vector. Having the CM, the FCB, the SCB and the aft propeller aft thrust vector aligned will generally aid in having the OAV descend straight downward. Preferably the aft propeller axis lies along the primary axis, and the aft propeller aft thrust vector extends aft along the primary axis. Thus, the FCB, the SCB, the CM, and the aft propeller axis are collinear (as well as being collinear with the CL and the forward propeller axis). The forward and aft thrust vectors are thus substantially in opposite directions. Nevertheless, in some embodiments some offset of the aft thrust vector could be used to compensate for other factors such as an offset center of pressure for aft travel through water.

As a result of CM and the FCB lying along the axis of the aft propeller (i.e., being collinear), the natural floating orientation provides for the aft propeller to be gravitationally below the forward propeller, and further provides for the aft propeller aft thrust vector to point vertically downward (with respect to gravity). The OAV density is high enough to provide for the OAV to extend deeply enough into the water for the aft propeller to be supported in a location that is fully submerged in the water when the OAV is floating in the natural floating orientation, and for the aft thrust vector in normal operation to point vertically downward. Thus, the OAV is configured to submerge vertically downward when the aft propeller provides aft thrust while the OAV is floating in the natural floating orientation. With the SCB collinear with the FCB and the CM (along the primary axis), the OAV is inclined to submerge vertically downward when the aft propeller provides aft thrust while already submerged.

To begin UUV operation, with the OAV substantially in its natural floating orientation (i.e., with the aft propeller submerged and the primary axis in the relatively vertical orientation), the OAV aft motor 109 drives the aft propeller 107 to achieve a level of aft-propeller aft thrust 221. The total buoyancy 225 of the OAV is less than the sum of the weight 223 of the OAV and the maximum level of aft-propeller aft thrust. The aft motor is a brushless motor that can operate while submerged and filled with water. The aft-propeller thrust submerges the OAV by moving in the aft direction, while in a relatively vertical orientation. The control surfaces 127, 129 may then be used to control the orientation and underwater direction of travel of the OAV. To return to the surface, the aft motor is stopped, and the buoyancy of the OAV returns it to the surface and rotates it to its natural floating orientation (with the primary axis extending nose-up in the gravitationally vertical direction).

Optionally, the control system and drive system can be configured to operate the aft motor in a forward thrust mode (i.e., reverse thrust) that produces thrust in the forward direction of the OAV. This mode can be used to assist the forward propeller during the transition between the floating mode of operation and UAV operation. This assistance may provide for faster departures from the water, and therefore less risk of failure due to surface turbulence.

Optionally, the aft motor and control surfaces may be used to controllably guide the OAV to the surface prior to turning off the aft motor and letting buoyancy take over. This could be accomplished using either aft-motor aft thrust wherein, the OAV moves in the aft direction and uses the control surfaces to turn the vehicle upward), or with aft-motor forward thrust (i.e., aft motor reverse thrust), wherein the OAV moves in the forward direction while possibly using the control surfaces to keep the OAV oriented to face the surface). Also, the forward motor and propeller could be used in the water to provide additional aft or forward thrust. While this is not an efficient environment for use of the forward propeller, there could still be some benefit.

It should be noted that the weight and buoyancy configuration of the OAV, having a structure serially laid out from forward to aft with the forward propeller 107, the forward motor 105, the FCB 201, the CM 203, the CL 205, the aft motor 109 and the aft propeller 111, provides for a propulsion system that can operate in either UAV or UUV modes of operation from the natural floating orientation of the OAV while floating. Variations of this configuration might differ. For example, the FCB may be formed slightly off the primary axis such that the OAV takes off not perfectly vertically, but rather in a climbing orientation in which the upper side of the wing faces slightly upward.

The skeletal form of this embodiment aids in achieving the desired weight and buoyancy configuration. The empennage servos being located on the wing provides for no electrical wires having to extend to the empennage, as well as for reducing the weight of the empennage and providing for a CM that is more forward. To further aid in achieving the desired weight and buoyancy configuration, a leading edge portion 301 of the wing is embedded with a buoyant material or a hollow, hermetically sealed space.

The OAV may be further configured with a payload, which might be incorporated into the control module 161. The payload will typically be a sensory package configured to gather data during the UUV, UAV and/or floating modes of operation. For example, the payload might include a camera for use in the UAV mode, and oil detection equipment for use in the floating and UUV modes. Thus the OAV could be configured to test for the presence of oil from an oil spill by viewing the water from above, and by testing the water on and below the surface. With the ability to repeatedly transition between flight modes, the OAV could be configured (e.g., programmed) to search for signs of oil from the air and then automatically test suspect locations, providing for rapid and detailed situational analysis covering locations both on and below the surface. A fleet of such OAV could be quickly and cost effectively deployed whenever an oil spill occurs.

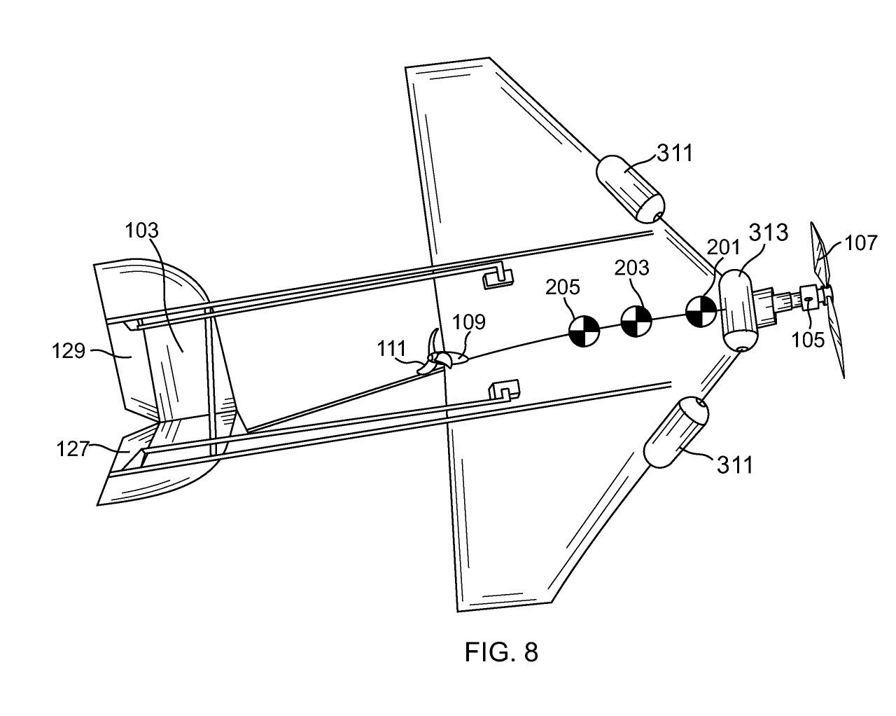

With reference to FIG. 8, a second embodiment of the invention is configured as the first, but the wing includes one or more wing-mounted floatation pods 311, and a bottom external flotation pod 313 may be added to the underside of the wing below or surrounding the control module 161. The bottom pod is buoyant and characterized by a bottom pod center of buoyancy. As a result of the wing pods, the starboard side of the wing is buoyant and characterized by a starboard-wing center of buoyancy, and the port side of the wing is buoyant and characterized by a port-wing center of buoyancy. The bottom pod center of buoyancy, the starboard center of buoyancy and the port center of buoyancy form a triangle.

These pods are flotation devices that provide for an OAV designer to easily set the buoyancy level, FCB and SCB of the OAV where desired, and thus to better stabilize the OAV while it is floating. The triangular positioning of their centers of buoyancy provides for a more stable, triangular flotation base, though potentially at the expense of the balance between weight, volume and air and water resistance. The CM and FCB define a line that passes through the triangle, thus providing for stability of orientation. Any additional pods or portions of pods that are above the waterline when the OAV is floating in the natural floating orientation and at the natural floating depth can help control the location of the SCB. Also, if the bottom pod is not as far off the primary axis as the other two (and thus has less of a moment arm for its restoring force), it can be configured with more flotation material above the water line to provide additional restoring force when the OAV rocks toward the bottom pod due to wind or waves. It should be noted that embodiments having no pods, or embodiments having only one pod (e.g., the lower pod), can be configured with adequate dihedral and buoyancy adaptations such that the FCB and CM align to place the OAV in a stable nose-up orientation while floating. Such an OAV does not necessarily have the FCB and CM within a structural portion of the aircraft.

With reference to FIG. 1, variations on either of the first two embodiments may be provided with natural floating orientation stabilization that is actively achieved. In a first variation of this concept, the OAV may be configured such that the aft propeller, when operated in the forward thrust direction by the control system, produces a backwash that streams across the control surfaces 127, 129. The control system may then operate the control surfaces (via the servos) to deflect the backwash in a vectoring direction, and thereby create a restoring force in the opposite direction that stabilizes the OAV by pushing it toward the natural floating orientation of the OAV (e.g., a nose up, vertical flight orientation). Optionally, the aft propeller can be mounted on an extended shaft such that the propeller is located closer to the empennage than the wing, thereby increasing the flow deflected by the control surfaces.

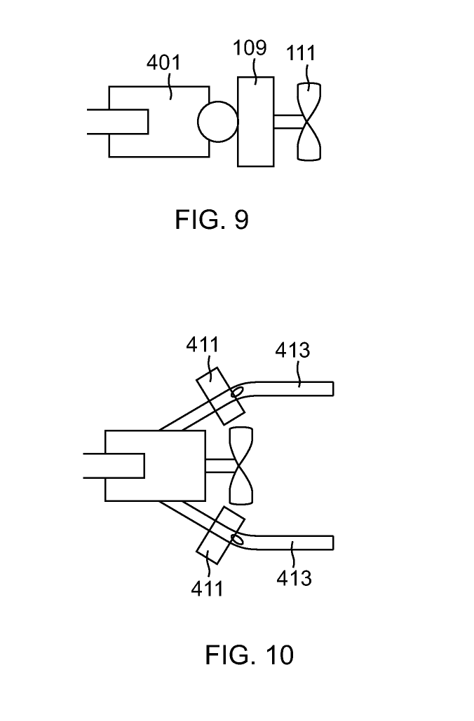

With reference to FIGS. 9 & 10, in a second and third variation of either of the embodiments, the aft propeller 111 is a vectored propeller that can alter the direction of its thrust. In the second variation, the aft propeller is configured with one or more propeller servos 401 configured to turn the aft propeller (and optionally the aft motor 109). In the third variation, the aft propeller has vane servos 411 that move vanes 413 configured to turn (i.e., divert) the propeller's resulting water stream (i.e., flow).

The OAV also includes an orientation sensor system, which may be in any known form, including in the form of two or more depth sensors located at various locations along the OAV. In any of the above-described orientation stabilization variations, the control system controls the aft propulsion vectoring direction in response to orientation information from the orientation sensor system to actively maintain the primary axis in the gravitationally vertical, nose-up orientation. In each variation, the OAV is thereby provided with an active control system configured to controllably direct fluid flow from the aft propeller such that tilting of the vehicle is limited while floating in on a turbulent surface (e.g., on rough water). In addition to establishing the orientation of the OAV, the depth sensors may also provide information for tracking the depth of the OAV and for making control system decisions regarding underwater operation.

For the OAV to operate as a UUV, it must be relatively waterproof, that is to say, its critical components must either be able to operate wet, or be hermetically sealed. In the later case, they must be designed with their effect on the OAV buoyancy in mind. For some designs this may mean the sealed portion must have only limited airspace so as not to make the OAV excessively buoyant, which would limit its ability to submerge and maneuver. One useful technique to accomplish this is to enclose solid-state electronics and related components (e.g., receivers, speed controls, connectors, batteries, and the like) in shrink tubing that is potted at both ends with a waterproof, rubbery sealant (as is commercially available). Also, while the motors are allowed to fill with water, the servos are potted around all internal electronics, and the gearbox portion is filled with low-viscosity oil. Alternatively, the sealed portions could be designed to operate as the above-described flotation pods. It should be noted that UAV's are not known for being hermetically sealed, partly because ensuring a seal introduces additional weight that would decrease available effective lift and flight maneuverability, and because of the increased manufacturing costs.

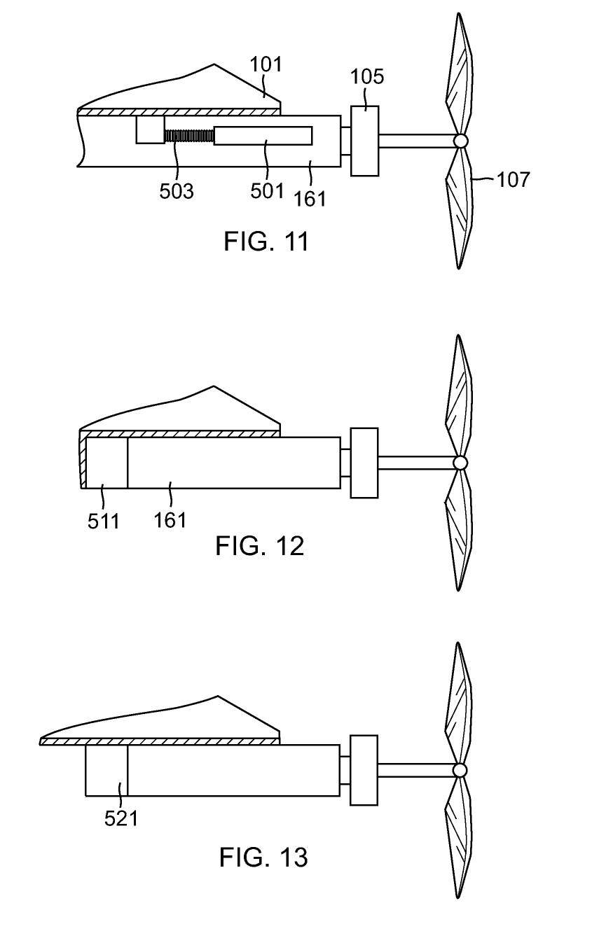

With reference to FIGS. 11-13, another variation that is applicable to either of the two embodiments is to have controllable characteristics that adjust to the divergent needs of the UAV and UUV modes of operation. For example, while static geometry partially limits the location of the CM, FCB and SCB, internal mass variation (i.e., moving or changing) may be used to adjust the mass or CM during operation. In one variation, a component such as a battery 501 is controllably relocated, such as being moved through the control module 161 via an actuator 503. In another variation there could be mass changing through chemical triggers, (e.g., by letting water come into contact with a dissolvable mass tablet 511 at a particular location, such as adjoining the control module 161). In yet another variation there could be compartment control (e.g., a membrane 521 could be allowed to become filled with water to increase mass and shift the CM). This variation could also provide for water samples to be gathered.

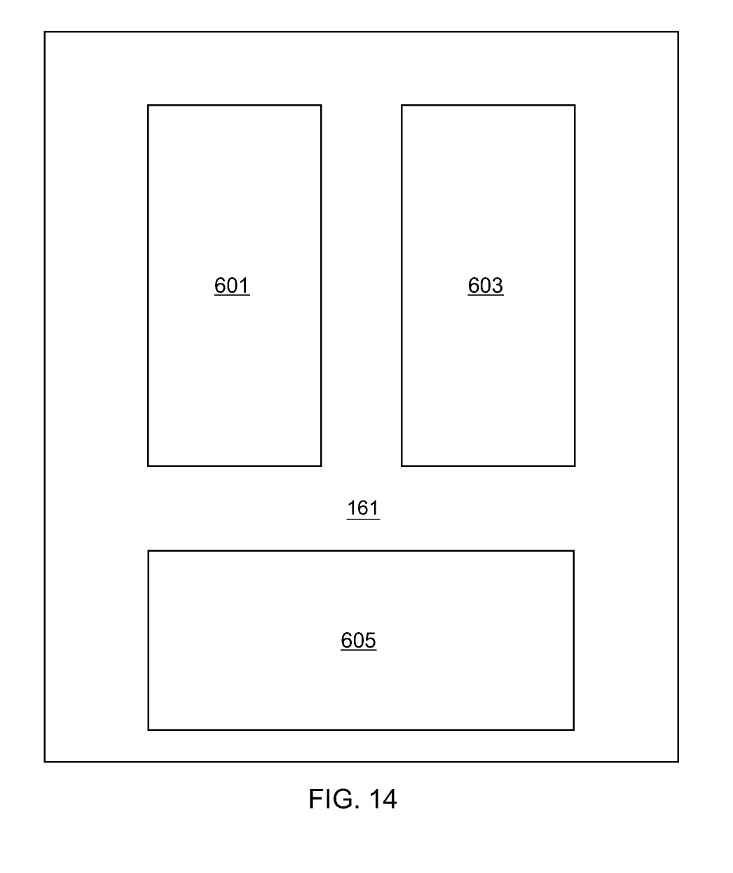

With reference to FIG. 14, radio frequency signals, as well as much of the electromagnetic spectrum in general, are severely attenuated underwater, and get weaker at greater depths. Thus, in another optional variation to either embodiment, the control module 161 might include the necessary programmable control system 601 for operating independently underwater, even if the OAV is configured with electronics 603 such that it operates simply as a remote control aircraft while in UAV operation. These systems might cooperate with a common controller 605 that directs servo and motor operations. This will allow the OAV to operate independently at greater depths and avoid the motion and debris that may be more pervasive near the surface. The programmable control system may be configured only for underwater operation, or it may be configured for full mission control. Moreover, a squadron of OAVs could be programmed to complete a coordinated mission, such as determining the scope and severity of an oil spill.

As should be apparent from the description of the OAV, the present embodiment of an OAV transitions back and forth between a UAV airborne flight mode of operation and a UUV submerged mode of operation by passing through a floating mode of operation and (when transitioning to UAV mode) vertical flight, i.e., a helicopter mode of operation. Thus, within the scope of the invention is a method of transitioning the OAV between a first mode of operation and a second mode of operation, where the first and second modes of operation are both taken from the group consisting of an airborne flight mode of operation and a submerged mode of operation. The first and second modes of operation may be different modes of operation, or may be the same mode of operation (e.g., an OAV lands and then takes off again without submerging). For example, oil spill detection OAVs might be configured only for aerial surveillance and surface testing.

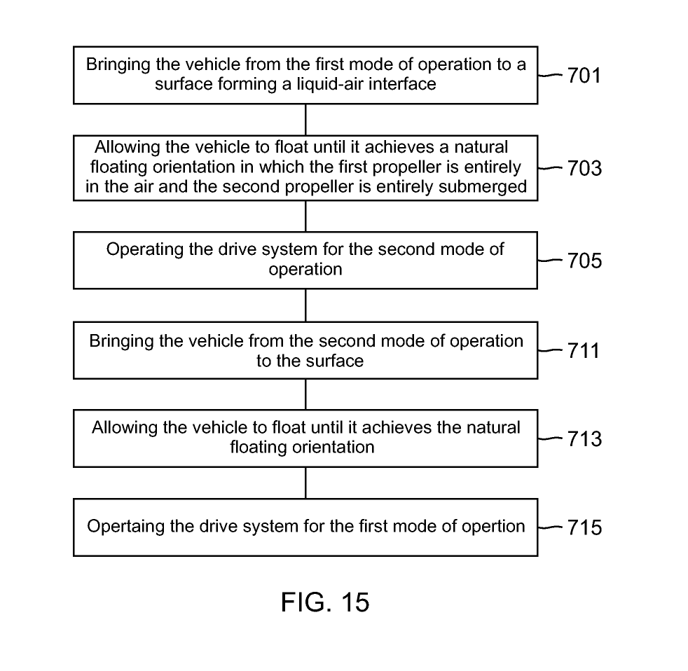

With reference to FIG. 15, included in the method are the steps of bringing the vehicle from the first mode of operation to a surface forming a liquid-air interface 701, allowing the vehicle to float until it achieves a natural floating orientation in which the forward propeller is entirely in the air and the aft propeller is entirely submerged 703, and operating the drive system for the second mode of operation 705. The method might also include the steps of bringing the vehicle from the second mode of operation to the surface 711, allowing the vehicle to float until it achieves the natural floating orientation 713, and operating the drive system for the first mode of operation 715, particularly if the first and second modes of operation are different.

For the present embodiment of a method, it may be that the first, mode of operation is the airborne flight mode of operation, while the second mode of operation is the submerged mode of operation. For the above-described OAV embodiments, in both steps of allowing in the method, the natural floating orientation provides for the first, forward propeller forward thrust vector to be substantially upward (e.g., vertically upward, and more generally, more upward than sideward). Also, for the above-described OAV embodiments, in both steps of allowing in the method, the natural floating orientation provides for the second, aft propeller aft thrust vector to be substantially downward (e.g., vertically down, or more generally, more downward than sideward). As a result, the vehicle accelerates vertically out of the water in a helicopter mode of operation, and then transitions into aircraft flight.

Many (though not all) embodiments of the present invention reside in an OAV that is configured with dual propulsion systems that each become naturally located in its intended environment while the OAV is floating. This provides for the OAV to operate in opposite directions depending on whether it is acting as an UAV or a UUV. While the OAV has been described as having only one source of thrust for flight (e.g., a forward propeller) and one source of thrust for underwater excursions (e.g., an aft propeller), additional sources (e.g., two forward propellers) and/or different types of sources of thrust (e.g., a pressurized stream of air or water) are contemplated within the scope of the invention.

A variation of the OAV could be configured with a propeller for propulsion for only one mode of operation. For example, the propeller could be used for flight, and some other form of depth control (such as a gas filled bladder of controllable volume on an OAV that is otherwise denser than water. As another example, the OAV could be neutrally buoyant, but have its center of buoyancy (in this case the SCB) located with respect to the CM such that while submerged in calm water it tends to orient itself in a vertical orientation with the forward propeller facing upward in the water i.e., the natural floating orientation of the earlier embodiments). Then, the aft propeller (or even the forward propeller if the plane lacks an aft propeller) could be used to reach the surface. If the surface is approached with adequate momentum, the forward propeller can leave the water (i.e. go above the surface) and then operate in air for transition to the UAV mode of operation.

Typical embodiments of the invention will generally have lower volume than a comparable UAV, and lower weight that a comparable UUV.

It is to be understood that the invention comprises apparatus and methods for designing OAVs, and for producing OAVs, as well as the apparatus and methods of the OAV itself. Additionally, the various embodiments of the invention can incorporate various combinations of these features with typical UAVs, UUVs and/or other related systems. In short, the above disclosed features can be combined in a wide variety of configurations within the anticipated scope of the invention.

While particular forms of the invention have been illustrated and described, it will be apparent that various modifications can be made without departing from the spirit and scope of the invention. For example, it is within the broadest scope of the invention for the vehicle to be configured only for transitioning between UAV and floating modes of operation. Such a vehicle would lack a UUV propulsion system, but would still be configured with the orientation characteristics that provide for vertical takeoff. Thus, although the invention has been described in detail with reference only to the preferred embodiments, those having ordinary skill in the art will appreciate that various modifications can be made without departing from the scope of the invention. Accordingly, the invention is not intended to be limited by the above discussion, and is defined with reference to the following claims.

What is claimed is:

1. A vehicle for use with a body of liquid having a surface, comprising:
a structure including wing defining opposite forward and aft directions for winged flight;
a first propulsion unit including a first thrust device mounted and configured for providing thrust for airborne flight above the surface, the first thrust device establishing a first thrust vector having a component in the forward direction; and
wherein the vehicle density is low enough for the vehicle to float in the body of liquid;
wherein the vehicle is characterized by a natural floating orientation in which, with the vehicle floating, the first thrust device is positioned above the surface for initiating airborne flight in an upward direction with respect to gravity.

2. The vehicle of claim 1, wherein:
the first thrust device is a first propeller mounted for rotation around a first propeller axis that defines a first propeller forward thrust vector having a substantial component in the forward direction, the first propeller being configured for flight above the surface; and
the first propulsion unit further includes a drive system including a motor configured to drive the first propeller in rotation around the first propeller axis to create thrust along the first propeller forward thrust vector; and
with the vehicle floating in the body of liquid, and oriented in its natural floating orientation, the structure supports the first propeller such that the first propeller is not submerged in the body of liquid.

3. The vehicle of claim 2, wherein the floating center of buoyancy, the center of mass and the first propeller axis are collinear.

4. The vehicle of claim 2, and further comprising:
a second propeller mounted for rotation around a second propeller axis that defines a second propeller aft thrust vector having a substantial component in the aft direction, the second propeller being configured for use in the body of liquid; and
wherein the drive system is configured to drive the second propeller in rotation around the second propeller axis to create thrust along the second propeller aft thrust vector; and
wherein, with the vehicle floating in the body of liquid, and oriented in its natural floating orientation, the structure supports the second propeller such that the second propeller is submerged in the body of liquid.

5. The vehicle of claim 4, wherein the first propeller forward thrust vector and the second propeller aft thrust vector are in opposite directions.

6. The vehicle of claim 4, wherein the floating center of buoyancy, the center of mass and the second propeller axis are collinear

7. The vehicle of claim 4, wherein the submerged center of buoyancy, the center of mass and the second propeller axis are collinear.

8. The vehicle of claim 4, wherein:
the submerged center of buoyancy, the floating center of buoyancy, the center of mass, the first propeller axis and the second propeller axis are collinear; and
the first propeller forward thrust vector and the second propeller aft thrust vector are in opposite directions.

9. The vehicle of claim 4, wherein the vehicle is characterized by a positive total buoyancy that is less than the sum of the weight of the OAV and the total amount of thrust that the drive system can develop from the second propeller in the body of liquid.

10. The vehicle of claim 4, and further comprising a control system configured to control the drive system such that the first propeller is used for propulsion when the vehicle is airborne, and such that the second propeller is used for propulsion when the vehicle is submerged.

11. The vehicle of claim 4, and further comprising an active control system configured to controllably direct fluid flow from the second propeller such that tilting of the vehicle is limited while floating on a turbulent surface.

12. The vehicle of claim 11, wherein:
the second propeller is positioned such that its backwash can be streamed across one or more control surfaces;
the active control system is configured to controllably direct the drive system to operate the second propeller such that its backwash streams across the control surfaces; and
the active control system is configured to controllably direct one or more control surface actuators to deflect the one or more control surfaces.

13. A method of cycling the vehicle of claim 2 between an airborne flight mode of operation and a floating mode of operation, comprising:
bringing the vehicle from the flight mode of operation to the surface;
allowing the vehicle to float at the surface until it achieves a natural floating orientation in which the first propeller is not submerged; and
operating the drive system to achieve the flight mode of operation.

14. A method of transitioning the vehicle of claim 2 between a first mode of operation from the group consisting of an airborne flight mode of operation and a submerged mode of operation, to a second mode of operation from the group consisting of the airborne flight mode of operation and the submerged mode of operation, comprising:
bringing the vehicle from the first mode of operation to the surface;
allowing the vehicle to float at the surface until it is adequately close to the natural floating orientation to transition to the second mode of operation;
and operating the drive system for the second mode of operation.

15. The method of claim 14, wherein the first mode of operation is different from the second mode of operation.

16. The method of claim 15, and further comprising the subsequent sequential steps:
bringing the vehicle from the second mode of operation to the surface;
allowing the vehicle to float at the surface until it is adequately close to the natural floating orientation to transition to the first mode of operation; and
operating the drive system for the first mode of operation.

17. The method of claim 16, wherein:
the first mode of operation is the airborne flight mode of operation;
the second mode of operation is the submerged mode of operation;
in both steps of allowing, the natural floating orientation provides for the first propeller forward thrust vector to be substantially upward; and
in both steps of allowing, the natural floating orientation provides for the second propeller aft thrust vector to be substantially downward.

18. The method of claim 17, wherein in the step of operating the drive system for the first mode of operation, the vehicle accelerates vertically out of the body of liquid and then transitions into winged flight.

19. A vehicle for use with a body of liquid having a surface, comprising:
a wing defining opposite forward and aft directions for winged flight;
a first propulsion unit including a first thrust device mounted and configured for providing thrust for airborne flight above the surface, the first thrust device establishing a first thrust vector having a component in the forward direction; and
a second propulsion unit including a second thrust device mounted and configured for providing thrust for in the body of liquid, the second thrust device establishing a second thrust vector having a component in the aft direction.

20. The vehicle of claim 19, wherein:
the first thrust device is a first propeller mounted for rotation around a first propeller axis that defines a first propeller forward thrust vector having a component in the forward direction, the first propeller being configured for airborne flight above the surface;
the second thrust device is a second propeller mounted for rotation around a second propeller axis that defines a second propeller aft thrust vector having a component in the aft direction, the second propeller being configured for thrust in the body of liquid; and
the first and second propulsion units are provided with a drive system including one or more motors, the drive system being configured to drive the first propeller in rotation about the first propeller axis to create thrust along the first propeller forward thrust vector, and to drive the second propeller in rotation about the second propeller axis to create thrust along the second propeller aft thrust vector.

21. The vehicle of claim 19, wherein:
the vehicle is characterized by a center of mass;
the vehicle is characterized by a floating center of buoyancy; and
the center of mass is aft of the floating center of buoyancy.

22. The vehicle of claim 21, wherein the first propeller axis is the same as the second propeller axis, and wherein the first propeller forward thrust vector is opposite the second propeller aft thrust vector.

23. The vehicle of claim 22, wherein the center of mass and the floating center of buoyancy lie along the second propeller axis.

24. The vehicle of claim 21, wherein the vehicle is further characterized by a submerged center of buoyancy that is forward of the center of mass, and wherein the submerged center of buoyancy and the center of mass both lie along the second propeller axis.

25. The vehicle of claim 21, and further comprising:
a buoyant pod under the wing and characterized by a pod center of buoyancy;
wherein the starboard side of the wing is buoyant and characterized by a starboard-wing center of buoyancy;
wherein the port side of the wing is buoyant and characterized by a port-wing center of buoyancy;
wherein the pod center of buoyancy, the starboard center of buoyancy and the port center of buoyancy form a triangle; and
wherein the center of mass and the floating center of buoyancy define a line that passes through the triangle.

26. The vehicle of claim 19, wherein the vehicle is characterized by a positive total buoyancy that is less than the sum of the weight of the OAV and the total amount of thrust that the drive system can develop from the second propeller in the body of liquid.

27. The vehicle of claim 19, and further comprising a control system configured to control the drive system such that the first propeller is used for propulsion when the vehicle is airborne, and such that the second propeller is used for propulsion when the vehicle is submerged.

28. The vehicle of claim 19, and further comprising an active control system configured to controllably direct fluid flow the second propeller such that tilting of the vehicle is limited while floating on a turbulent surface.

29. The vehicle of claim 28, wherein:
the second propeller is positioned such that its backwash can be streamed across one or more control surfaces;
the active control system is configured to controllably direct the drive system to operate the second propeller such that its backwash streams across the control surfaces; and
the active control system is configured to controllably direct one or more control surface actuators to deflect the one or more control surfaces.

30. The vehicle of claim 19, wherein the vehicle is characterized by a natural floating orientation in which the vehicle, while floating, has its first propeller located above the surface and positioned for initiating airborne flight in a forward direction, and has its second propeller located below the surface and positioned for initiating submerged travel in a rearward direction.

31. A method of transitioning the vehicle of claim 30 between a first mode of operation from the group consisting of an airborne flight mode of operation and a submerged mode of operation, to a second mode of operation from the group consisting of the airborne flight mode of operation and the submerged mode of operation, comprising the sequential steps:
bringing the vehicle from the first mode of operation to the surface;
allowing the vehicle to float at the surface until it is adequately close to the natural floating orientation to transition to the second mode of operation; and
operating the drive system for the second mode of operation.

32. The method of claim 31, wherein the first mode of operation is different from the second mode of operation.

33. The method of claim 31, and further comprising the subsequent sequential steps:
bringing the vehicle from the second mode of operation to the surface;
allowing the vehicle to float at the surface until it is adequately close to the natural floating orientation to transition to the first mode of operation; and
operating the drive system for the first mode of operation.

34. The method of claim 33, wherein:
the first mode of operation is the airborne flight mode of operation;
the second mode of operation is the submerged mode of operation;
in both steps of allowing, the natural floating orientation provides for the first propeller forward thrust vector to be substantially upward; and
in both steps of allowing, the natural floating orientation provides for the second propeller aft thrust vector to be substantially downward.

35. The method of claim 34, wherein in the step of operating the drive system for the first mode of operation, the vehicle accelerates vertically out of the body of liquid and then transitions into winged flight.

36. A vehicle for use with a body of liquid having a surface, comprising:
a structure including wing defining opposite forward and aft directions for winged flight;
a propeller mounted for rotation around a propeller axis that defines a propeller forward thrust vector having a substantial component in the forward direction, the propeller being configured for airborne flight above the surface; and
a drive system including a motor configured to drive the propeller in rotation around the propeller axis;
wherein the vehicle is characterized by a vehicle submerged center of buoyancy that is adequately forward of a vehicle center of mass such that the vehicle, when submerged in the body of liquid, will orient with the propeller axis in a substantially vertical direction with respect to gravity;
wherein the vehicle is configured to operate its propeller while submerged in the body of liquid to ascend to the surface such that the propeller passes above the surface; and
wherein the vehicle is configured to operate the propeller above the surface to vertically launch the vehicle for airborne flight.
